(19) United States
(12) Patent Application Publication
(10) Pub. No.: US 2018/0086395 A1
(43) Pub. Date: Mar. 29, 2018

(54) AERODYNAMIC NOSE DEVICE

(71) Applicant: WABASH NATIONAL, L.P., Lafayette, IN (US)

(72) Inventors: Jonathan Loiben, Lafayette, IN (US); James A. Sweet, Lafayette, IN (US); Brian N. Haan, Lafayette, IN (US); Leonard W. Baker, Lafayette, IN (US)

(21) Appl. No.: 15/279,846

(22) Filed: Sep. 29, 2016

(51) Int. Cl. B62D 35/00

(52) U.S. Cl. CPC B62D 35/001; B62D 35/005

(57) ABSTRACT

A device for reducing aerodynamic drag comprises a fairing structure configured to be attached to a vehicle surface. The fairing structure comprises a curved wall, a rounded edge, and a substantially flat wall. The substantially flat wall is connected to a mounting surface configured to be attached to the surface of the vehicle.

### FIELD OF THE INVENTION

The present disclosure relates generally to tractor-trailers. In particular, the present disclosure relates to an aerodynamic nose device designed to reduce the drag force produced by a standard tractor-trailer.

### BACKGROUND

To reduce wind flow resistance and drag on a trailer, truck, semitrailer, or other vehicle, side skirts which extend downwardly from a bottom of the trailer and/or chassis toward the roadway to partially enclose the floor assembly and undercarriage of the trailer, fairings, and other such structures have been used. Many structures associated with the front of the trailer are provided in order to also reduce the aerodynamic drag on the trailer.

Air flow passing over a semi or other vehicle may come into contact with a flat face of a tractor-trailer, imparting a drag force to the vehicle. Nose fairings and aerodynamic nose devices are designed to prevent or control the flow of air from contacting a leading flat face of a trailer, such as a trailer of a tractor-trailer truck system, for example. They accomplish this goal by providing a curved surface that directs air away from the leading flat face of the trailer. Such reduction on the drag of the ground vehicle may operate to conserve fossil fuels as well as other sources of vehicle drive power for hybrid vehicles, battery-operated vehicles, and alternative fuel-based vehicles, for example. Existing gap reducing and nose fairing structures provide rounded edges to reduce drag force, but may be shaped and positioned such that they create an additional drag force by over-handling the air.

Accordingly, there remains a need for further contributions in this area of technology, including contributions that further reduce drag force, optimize air flow, and allow for improved manufacturability and distribution.

### SUMMARY

The present disclosure may comprise one or more of the following features recited in the attached claims and combinations thereof, and/or one or more of the following features and combination thereof.

In one aspect, an aerodynamic nose device is configured to be coupled to a front surface of a vehicle and includes a fairing structure configured to be attached to a vehicle surface. The first fairing structure may comprise a curved wall having a first end and a second end, the first end configured for attachment to the vehicle surface, the curved wall having a radius of curvature of between about 11 inches and about 31 inches and a rounded edge having a first end and a second end, the first end of the rounded edge being connected to the second end of the curved wall. The first fairing structure may further comprise a substantially flat wall having a first end and a second end, the first end being connected to the second end of the rounded edge and the second end being connected to a mounting surface that is configured to be attached to the vehicle surface, wherein the flat wall is disposed at an angle of between about 60 degrees and about 90 degrees with respect to the mounting surface.

In some embodiments, the device further includes a mounting flange extending from the first end of the curved wall, the mounting flange configured to be attached to a second vehicle surface extending generally transverse to the first-named vehicle surface.

In some embodiments, the curved wall includes inner and outer curved wall surfaces, the rounded edge includes inner and outer rounded edge surfaces, and the substantially flat wall includes inner and outer flat wall surfaces wherein the curved wall outer surface, the rounded edge outer surface, and the flat wall outer surface form an aerodynamic surface and the curved wall inner surface, the rounded edge inner surface, and the flat wall inner surface form a cavity.

In some embodiments, the device further includes a further first-name fairing structure comprising a second curved wall, a second rounded edge, and a second substantially flat wall, wherein the further first-named fairing structure is nested within the cavity of the first-named fairing structure with an outer surface of the second curved wall adjacent the curved wall inner surface, an outer surface of the second rounded edge adjacent the rounded edge inner surface, and an outer surface of the second substantially flat wall adjacent the flat wall inner surface.

In some embodiments, the device further includes a second fairing structure coupled to the first-named fairing structure, the second fairing structure comprising a second curved wall, a second rounded edge, and a second substantially flat wall, the second fairing structure being coupled to a first end of the first-named fairing structure and positioned at an angle of about 90 degrees with respect to the first-named fairing structure. In some embodiments, the device further includes a third fairing structure coupled to the first-named fairing structure, the third fairing structure comprising a third curved wall, a third rounded edge, and a third substantially flat wall, the third fairing structure being coupled to a second end of the first-named fairing structure and positioned at an angle of about 90 degrees with respect to the first-named fairing structure, wherein the third fairing structure is parallel to the second fairing structure.

In some embodiments, each of the second and third curved walls comprises a plurality of depressions formed therein.

In some embodiments, the fairing structure comprises a plurality of depressions formed therein.

In some embodiments, the device comprises a thermoplastic olefin (TPO).

In another aspect, an aerodynamic nose device is configured to be coupled to a front surface of a vehicle and comprises a fairing structure configured to be attached to a front surface of a vehicle. The fairing structure comprises a first linear fairing segment comprising a curved wall having a first end and a second end, the first end configured for attachment to the front surface of the vehicle and a substantially flat wall having a first end and a second end, the first end being coupled to the second end of the curved wall. The fairing structure further comprises a second linear fairing segment extending from and substantially perpendicular to a first end of the first linear fairing segment, the second linear fairing segment including an end having a coupling cavity adapted to receive an end of a second fairing structure.

In some embodiments, the device further comprises a second fairing structure, wherein an end of the second fairing structure extends at least partially into the coupling cavity and is coupled to the second linear fairing segment by an interference fit or by one or more fasteners.

In some embodiments, the end of the second linear fairing segment includes a depression and the end of the second fairing structure includes a reduced dimension that conforms to the depression in the end of the second linear fairing segment.

In some embodiments, a portion of the second linear fairing segment and a portion of the second fairing structure have similar cross-sectional shapes.

In some embodiments, the device further comprises a third linear fairing segment extending from and substantially perpendicular to a second end of the first linear fairing segment opposite the first end, the third linear fairing segment comprising an end having a coupling cavity adapted to receive an end of a third fairing structure.

In some embodiments, the device further comprises a third fairing structure, wherein an end of the third fairing structure extends at least partially into the coupling cavity of the third linear fairing segment and is coupled to the third linear fairing segment by an interference fit or by one or more fasteners.

In some embodiments, the end of the third linear fairing segment includes a depression and the end of the third fairing structure includes a reduced dimension that conforms to the depression in the end of the third linear fairing segment.

In still another aspect, an aerodynamic nose device is configured to be coupled to a front surface of a vehicle and comprises a first fairing structure configured to be coupled to a front surface of a vehicle. The first fairing structure comprises a first wall having a first end and a second end with at least one of the first and second ends configured for attachment to the front surface, the first wall further including an inner surface and an outer surface, a first aerodynamic surface at least partially defined by the outer surface, and a first enclosed cavity at least partially defined by the inner surface. The device further includes a second fairing structure configured to be coupled to a front surface of a vehicle, the second fairing structure comprising a second wall having a first end and a second end with at least one of the first and second ends configured for attachment to the front surface, the second wall further including an inner surface and an outer surface, a second aerodynamic surface at least partially defined by the outer surface of the second wall, and a second enclosed cavity at least partially defined by the inner surface of the second wall. The second fairing structure is nested within the first fairing structure with the outer surface of the second wall of the second fairing structure positioned adjacent the inner surface of the first wall of the first fairing structure.

In some embodiments, the first wall comprises a first curved wall section having a first end and a second end, a first rounded edge having a first end and a second end, the first end of the first rounded edge being coupled to the second end of the first curved wall section, and a first substantially flat wall section having a first end and a second end, the first end being coupled to the second end of the first rounded edge and the second end being coupled to a mounting surface that is configured to be coupled to the front surface of the vehicle.

In some embodiments, the second wall comprises a second curved wall section having a first end and a second end, a second rounded edge having a first end and a second end, the first end of the second rounded edge being coupled to the second end of the second curved wall section, and a second substantially flat wall section having a first end and a second end, the first end being coupled to the second end of the second rounded edge and the second end being coupled to a mounting surface that is configured to be coupled to the front surface of the vehicle.

In some embodiments, the device further comprises a right vertical fairing structure configured to be coupled to the first fairing structure and positioned at an angle of about 90 degrees with respect to the first fairing structure and/or a left vertical fairing structure configured to be coupled to the first fairing structure and positioned at an angle of about 90 degrees with respect to the first fairing structure, wherein the left vertical fairing structure is configured to be parallel to the right vertical fairing structure.

In some embodiments, the device further comprises a second right vertical fairing structure nested within the right vertical fairing structure and a second left vertical fairing structure nested within the left vertical fairing structure.

These and other features of the present disclosure will become more apparent from the following description of the illustrative embodiments.

### BRIEF DESCRIPTION OF THE DRAWINGS

FIG. 1 is a top isometric view of a tractor-trailer including two pup trailers incorporating an aerodynamic nose device coupled to each trailer.

FIG. 2 is a side elevation view of a portion of the tractor-trailer of FIG. 1.

FIG. 3 is a top isometric view of one of the pup trailers of FIG. 1.

FIG. 4 is a front elevation view of the aerodynamic nose device of FIGS. 1-3.

FIG. 5A is a front elevation view of a top fairing structure of the aerodynamic nose device of FIGS. 1-4.

FIG. 5B is a cross-sectional view of the aerodynamic nose device of FIGS. 1-4 taken generally along the line 5B-5B of FIG. 5A.

FIG. 6A is a bottom elevation view of the top fairing structure of FIG. 5A.

FIG. 6B is a cross-sectional view of the top fairing structure of FIG. 5A taken generally along the line 6B-6B of FIG. 5A.

FIG. 7A is a front elevation view of a side fairing structure of the aerodynamic nose device of FIGS. 1-4.

FIG. 7B is a top elevation view of the side fairing structure of FIG. 7A.

FIG. 7C is a cross-sectional view of a portion of the side fairing structure of FIGS. 7A and 7B, the cross-section taken generally along the line 7C-7C of FIG. 7A.

FIG. 7D is a cross-sectional view of a different portion of the side fairing structure of FIGS. 7A and 7B, the cross-section taken generally along the lines 7D-7D of FIG. 7A.

FIG. 8A is a top and side isometric view of the top fairing structure of FIGS. 5A-6B and the side fairing structure of FIGS. 7A-7D in an unconnected state.

FIG. 8B is a top and side isometric view of the top fairing structure of FIGS. 5A-6B and the side fairing structure of FIGS. 7A-7D connected to one another.

FIG. 9 is an alternative embodiment of an aerodynamic nose device attached to a trailer.

FIG. 10A is an isometric view of several side fairing structures of FIGS. 7A-7D in a stacked or nested configuration.

FIG. 10B is an isometric view of several side fairing structures being mirror images of the side fairing structures of FIGS. 7A-7D in a stacked or nested configuration.

FIG. 10C is an isometric view of several top fairing structures of FIGS. 5A-6B in a stacked or nested configuration.

Corresponding reference characters indicate corresponding parts throughout the several views. Although the drawings represent embodiments of the present disclosure, the drawings are not necessarily to scale and certain features may be exaggerated in order to better illustrate and explain the embodiments of the present disclosure.

### DETAILED DESCRIPTION OF THE DRAWINGS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

For the purposes of promoting an understanding of the principles of the present disclosure, reference will now be made to a number of illustrative embodiments shown in the attached drawings and specific language 11 be used to describe the same. While the concepts of this disclosure are described in relation to an aerodynamic nose device for use in a semi-truck vehicle or a semi-truck vehicle trailer, it will be understood that it is equally applicable to other trailers and vehicles.

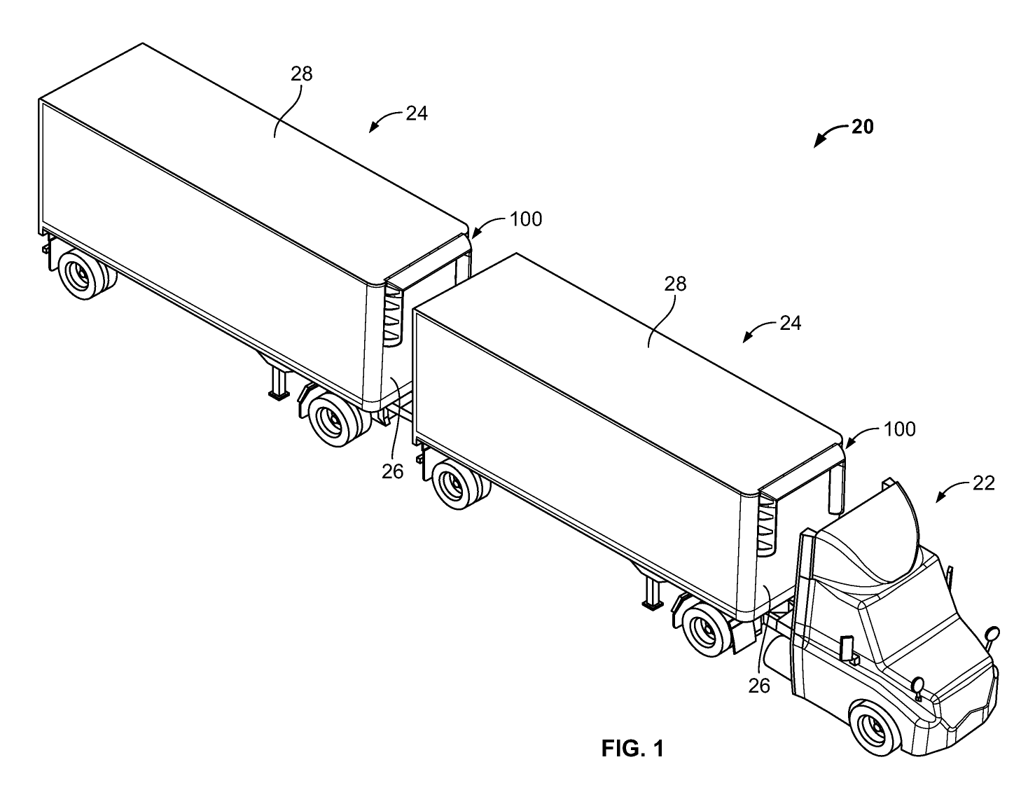

Turning now to FIG. 1, a semi tractor-trailer assembly 20 is depicted. A tractor 22 of the semi tractor-trailer may be configured to tow one or more pup trailers 24 or a longer trailer, such as a full-length trailer (not shown) for hauling any number of items. In some assemblies, a trailer 24 may be directly coupled to the tractor 22 or directly to another trailer 24, each of which are illustrated in FIG. 1. In yet other embodiments, a trailer 24 may connected to a vehicle other than a tractor 22.

The tractor-trailer assembly 20 further comprises an aerodynamic nose device 100. The aerodynamic nose device 100 may be positioned such that it protrudes outwardly from the leading face 26 of the pup trailer 24 or full-length trailer as it travels forward with the tractor 22. In some embodiments, the aerodynamic nose device 100 may be placed only on the trailer 24 immediately behind the tractor 22, while others may include an aerodynamic nose device 100 on the front surface 26 of each trailer 24 in the assembly. Further, in some examples, the aerodynamic nose device 100 may be placed only on a trailer 24 that is directly coupled to another trailer 24. While a semi-tractor trailer 20 having two pup trailers 24 is depicted, the aerodynamic nose devices disclosed herein may be utilized with semi-tractor trailers having only a single trailer 24 of any length.

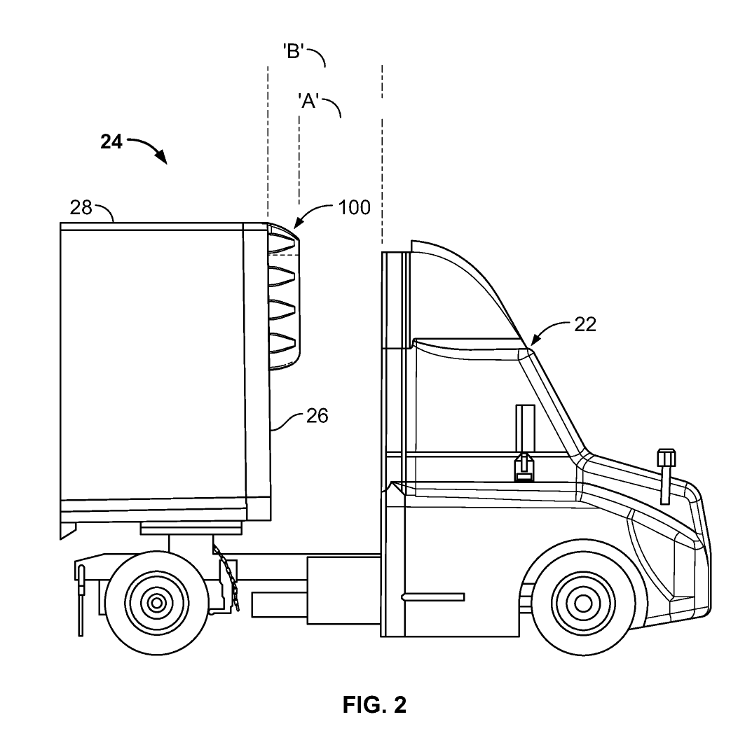

In some embodiments, the aerodynamic nose device 100 includes a mounting section that is substantially parallel to a top surface 28 of a trailer 24. In other embodiments, the aerodynamic nose device 100 may include a component that is aligned substantially flush with or parallel to the top surface 28 of a trailer 24. Referring now to FIG. 2, the aerodynamic nose device 100 is positioned such that it sits between the tractor 22 and trailer 24 (or optionally between two trailers 24).

The aerodynamic nose device 100 acts as a gap reducer to reduce aerodynamic drag generated by air coming into contact with the leading face 26 of a trailer 24. More particularly, the aerodynamic nose device 100 reduces the gap B to create an effective gap A, which may reduce the air flow that contacts the front face 26 of the trailer 24 as it is traveling forward. While a low pressure zone between the tractor 22 and trailer 24 may still urge some air downward, the aerodynamic nose device 100 can be shaped such that air is redirected away from the front face 26 of the trailer, thereby reducing the overall drag experienced by the assembly.

In a tractor-trailer assembly without an aerodynamic nose device, the gap B between the tractor 22 and the trailer 24 is large enough to create an area of low pressure between the tractor 22 and the trailer 24. Air is sucked down into the gap B because of the pressure differential between the air in the gap B and ambient air, thereby causing pressure drag. In addition to the pressure drag created, the air that flows into the gap then contacts the leading flat surface 26 of the trailer 24, which creates additional drag on the tractor-trailer assembly 20.

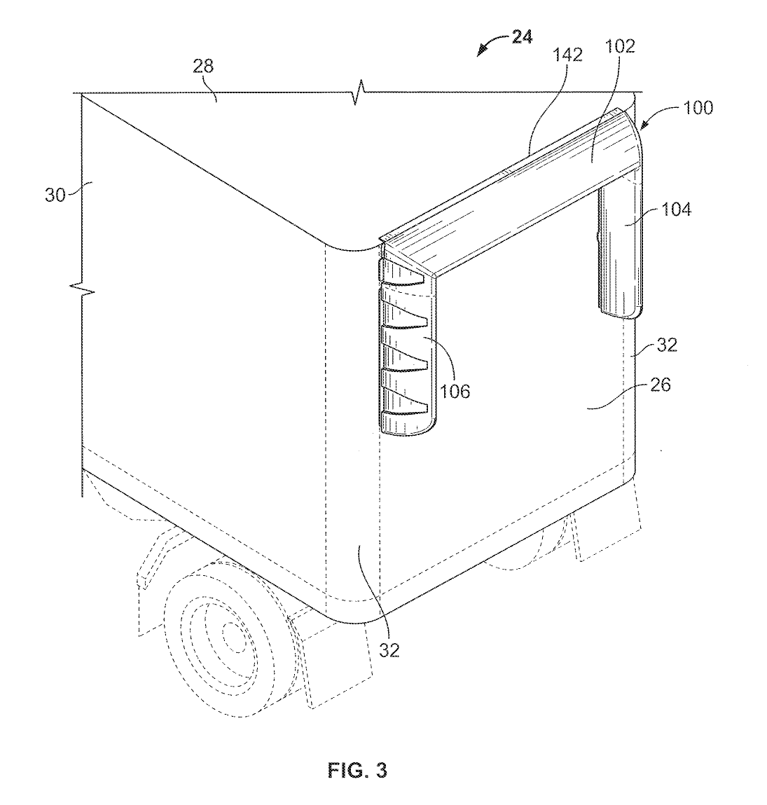

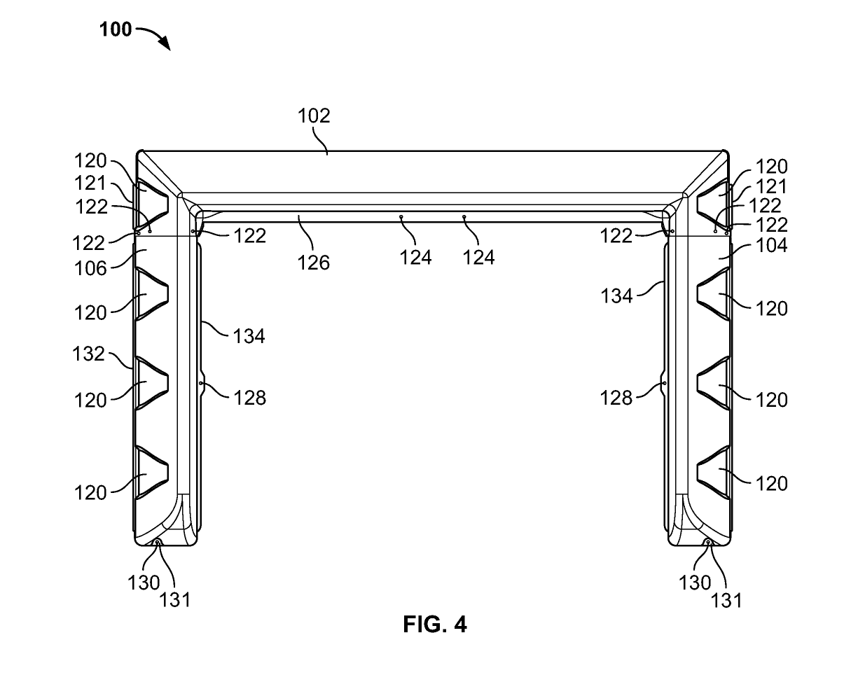

Turning now to FIGS. 3 and 4, the aerodynamic nose device 100 comprises a top fairing structure 102 that is configured to be coupled to the front surface 26 of the trailer 24 or other vehicle. While the components of the aerodynamic nose device 100 are described herein as being coupled to the front surface 26 of the trailer 24, the aerodynamic nose devices 100 disclosed herein may be utilized on any surface of a trailer 24 or other vehicle. In some embodiments, the top fairing structure 102 may be coupled to the top surface 28 of a trailer 24 or other vehicle, a front surface 26 of a trailer 24 or other vehicle, a side surface 30 of a trailer 24 or other vehicle, or any combination of these surfaces. Additionally, it is contemplated that some trailers 24 or other vehicles may have rounded edges 32, which may also be suitable for coupling the top fairing structure 102 (or any of the other fairing structures), and are similarly contemplated by the present disclosure.

The aerodynamic nose device 100 may optionally comprise additional fairing structures, such as a first side fairing structure 104 and a second side fairing structure 106. In some embodiments, the second fairing structure 104 and the third fairing structure 106 are coupled to top fairing structure 102, as will be discussed in more detail below. The first side fairing structure 104 and second side fairing structure 106 may be aligned such that they are substantially perpendicular with the top fairing structure 102. Similarly, the first side fairing structure 104 and the second side fairing structure 106 may be aligned such that they are substantially parallel to one another. In such cases of angular location, substantially may mean within ten degrees, five degrees, or within two degrees.

The first side fairing structure 104 and the second side fairing structure 106 may be configured to be coupled to the trailer 24. In some embodiments, the first and second side fairing structures 104 and 106 may be coupled to the top surface 28 of a trailer 24 or other vehicle, a front surface 26 of a trailer 24 or other vehicle, a side surface 30 of a trailer 24 or other vehicle, or any combination of these surfaces. Additionally, it is contemplated that some trailers 24 or other vehicles may have rounded edges 32, which may also be suitable for coupling one or both of the first and second side fairing structures 104 and 106, and are similarly contemplated by the present disclosure.

In some embodiments, the top fairing structure 102, the first side fairing structure 104, and the second side fairing structure 106 are configured to align with a portion of the outer perimeter of the front surface 26 of the trailer 24. In some embodiments, the first side fairing structure 104 and second side fairing structure 106 are mounted inside rounded edges 32, on front surface 26. In some embodiments, each of the first side fairing structure 104 and the second side fairing structure 106 extends along vertical edges of the front surface 26 of the trailer 24. In other embodiments, the first and second side structures 104 and 106 extend away from top fairing structure 102 such that only about half of the perimeter of the front face 26 of the trailer 24 is defined by components of an aerodynamic nose device 100, as seen in FIG. 3. In other words, the first and second side structures 104, 106 have a vertical extent that is about half of a height of the front surface 26. In still other embodiments, the first and second side fairing structures 104, 106 can be omitted entirely. It should be understood that the first and second side fairing structures 104, 106 may have any suitable length or vertical extent.

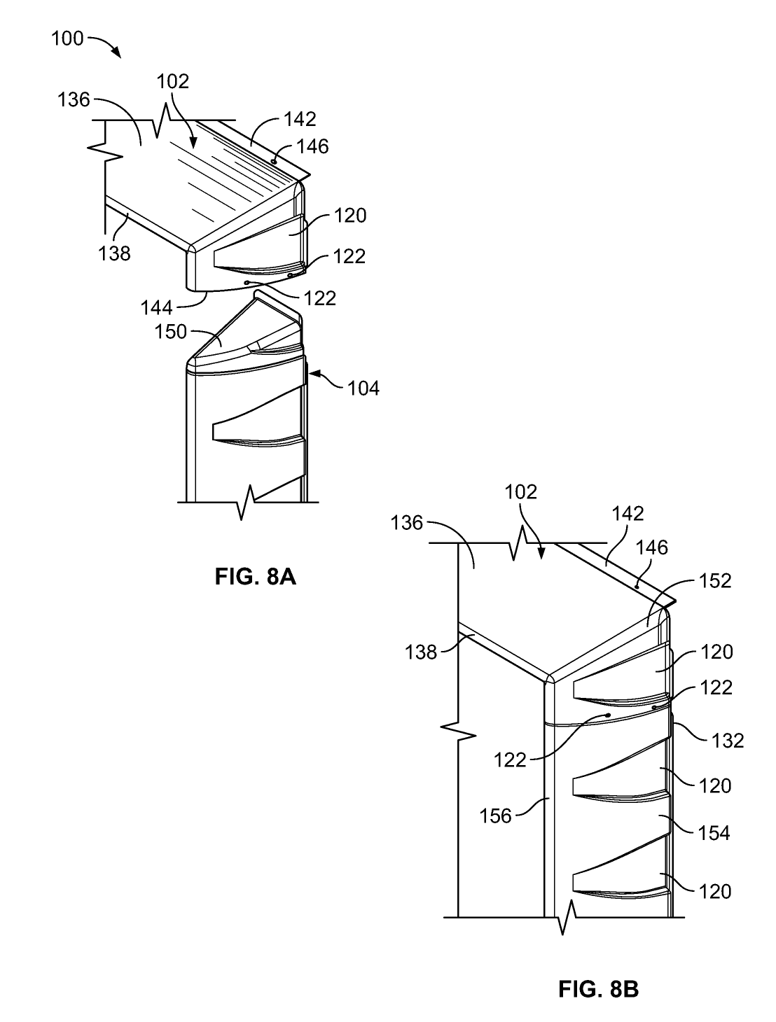

Turning now to FIG. 4, the first and second side fairing structures 104, 106 are coupled to the top fairing structure 102. The coupling may occur in a variety of ways. In one example, the top fairing structure 102 may include a plurality of apertures 122 that are configured to receive rivets or other fasteners that are configured to extend through the apertures 122. In some embodiments, a portion of first side fairing structure 104 and the second side fairing structure 106 may extend into portions of the top fairing structure 102, as will be explained later with reference to FIGS. 8A and 8B. Optionally in these and other embodiments, the first side fairing structure 104 and the second side fairing structure 106 may include threaded holes (not shown) that may be configured to line up substantially concentrically with the apertures 122 of the top fairing structure 102. The rivets or fasteners that extend through the apertures 122 may also extend through the threaded holes in the first and second side fairing structures 104, 106, where they are then held in place. In some embodiments, the top fairing structure 102 may be coupled to the first and/or second side fairing structures 104, 106 by an interference fit. It is also contemplated that top fairing structure 102 may be coupled to the first and/or second side fairing structures 104, 106 by adhesives. It should be appreciated that the methods for coupling the top fairing structure 102 to the first and/or second side fairing structures 104, 106 provided herein are in no way exhaustive, and other suitable coupling methods are similarly within the scope of the present disclosure. It should also be understood that in some embodiments, top fairing structure 102, first side fairing structure 104, and second side fairing structure 106 may be a single continuous component, and be manufactured as a single part.

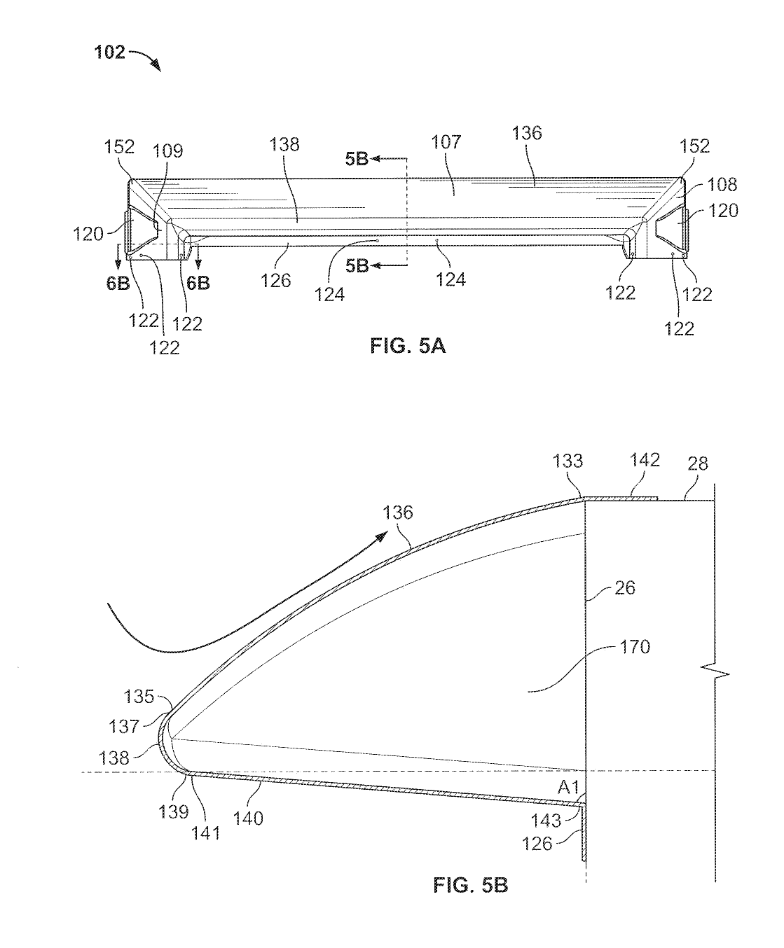

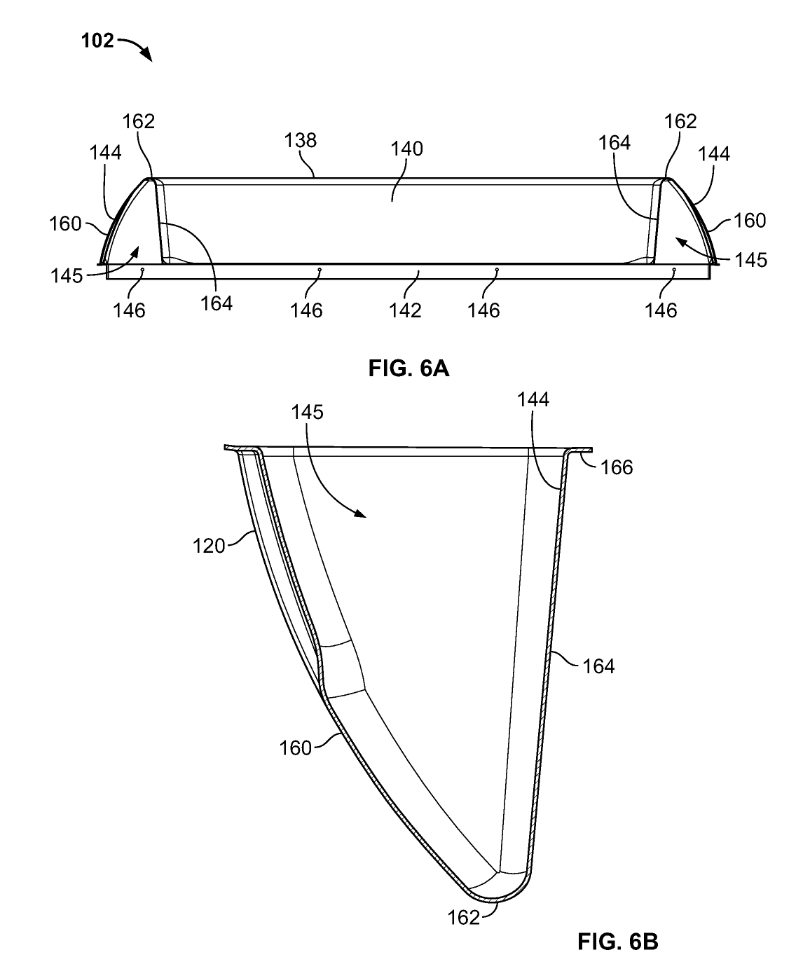

The aerodynamic nose device 100 may be mounted to one or more surfaces of the trailer 24 or other vehicle surface in a number of ways. In some embodiments, the aerodynamic nose device 100 comprises a plurality of mounting flanges. For instance, as seen in FIGS. 4-5B, the top fairing structure 102 may include a mounting flange 126, which may be coupled to the front surface 26 of a trailer, such as the trailer 24 shown in FIGS. 1 and 2. The mounting flange 126 may include a plurality of mounting apertures 124, which can be spaced apart on the mounting flange 126 and sized to accommodate fasteners or rivets that can be attached to a surface of a trailer. A variety of other mounting flanges may be placed about the top fairing structure 102, including side mounting tabs 121. The side mounting tabs 121 may be coupled to the front surface 26 of the trailer 24 or other vehicle, a side surface of the trailer 24 or other vehicle, the top surface 28 of the trailer 24 or other vehicle, rounded edges 32 of the trailer 24, or a combination of these surfaces. The top fairing structure 102 may optionally include an additional top mounting flange 142 or a plurality of top mounting tabs, which will be discussed in greater detail with reference to FIGS. 5B and 6A. It is further contemplated that the top fairing structure 102 may be coupled to a trailer in other suitable manners, such as for example adhesively.

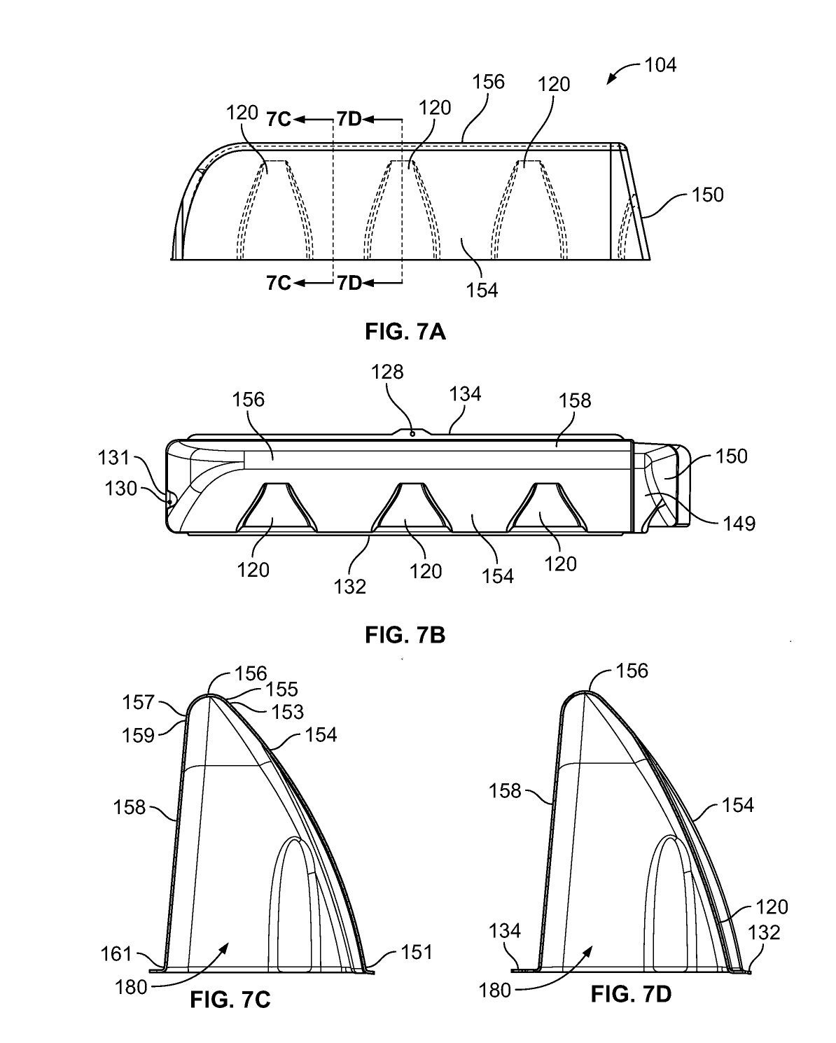

The first and second side structures 104, 106 may also be equipped with mounting flanges. In some embodiments, as best seen in FIGS. 7A-7D, the first and second side fairing structures 104, 106 may include inner mounting flanges 134, outer mounting flanges 132, a combination of the two, or neither. The inner mounting flange 134 may be configured to provide a substantially flat surface to be mounted to the front surface 26 of the trailer 24 or other vehicle. In some embodiments, the inner mounting flange 134 includes a plurality of apertures 128 spaced apart throughout, which are configured to accommodate fasteners or other coupling devices. In other embodiments, a single aperture 128 may be provided along the entirety of the inner mounting flange 134 and located near a middle of the inner mounting flange 134. It is contemplated, however, that many combinations of apertures, sizes of apertures, and locations of apertures may be used to successfully couple one or both of the first and second side fairing structures 104, 106 to the trailer 24 or other vehicle. Similarly, it is contemplated that a single mounting flange 134, a single mounting tab, or a plurality of mounting tabs may be used to provide adequate mounting.

Still referring to FIGS. 7A-7D, the first and second side fairing structures 104, 106 may also comprise an outer mounting flange 132. The outer mounting flange 132 may once again be configured to provide a substantially flat surface to be mounted to the front surface 26, a side surface, the top surface 28, and/or rounded edges 32 of the trailer 24 or other vehicle. In some embodiments, outer mounting flange 132 includes a plurality of apertures spaced apart throughout, wherein the apertures are configured to accommodate fasteners or other suitable coupling devices. It is contemplated, however, that many combinations of apertures, sizes of apertures, and locations of apertures may be used to successfully couple the first and/or second side fairing structures 104, 106 to the trailer 24 or other vehicle. Similarly, it is contemplated that a single mounting flange 132, a single mounting table, or a plurality of mounting tabs may be used to provide adequate mounting.

The first and second side fairing structures 104, 106 may also optionally include a bottom mounting tab 131, as shown in FIG. 4. The tab 131 may provide a flat face, such that the tab 131 forms a mounting surface for attachment to a surface of the trailer 24 or other vehicle. The tab 131 may also comprise an aperture 130 extending therethrough, the aperture being sized and positioned such that a fastener or other coupling device can be used to couple the first and/or second side structure 104, 106 to the trailer 24 or other vehicle surface.

Any of the top fairing structure 102, the first side fairing structure 104, and the second side fairing structure 106 may comprise depressions 120. The depressions 120 may take on a number of shapes and positions, including a frustotriangular shape such as that shown in the FIGS. 4, 7A, 7B, 8A, and 8B. The depressions 120 may be spaced apart regularly throughout each fairing structure, placed sporadically throughout each fairing structure, or placed in any number of arrangements. While a top surface of the top fairing structure 102 in the figures does not contain depressions 120, it should be understood that in some embodiments, the top surface of the top fairing structure 102 may include depressions. In other embodiments, one or more of the fairing structures 102, 104, 106 may not include depressions.

While depressions 120 may add a certain aesthetic element to the fairing structures and aerodynamic nose device 100 overall, some shapes can provide additional structural support to the fairing structures, should they experience axial loading while in use. For example, it is possible that a rear surface of a tractor 22 could come into contact with the aerodynamic nose device 100. The axial loading experienced by the aerodynamic nose device 100 may cause deflection. By having additional support from the depressions 120, the aerodynamic nose device 100 may be able to withstand additional axial loading without permanently deforming.

Turning now to FIGS. 5A and 5B, the top fairing structure 102 generally includes a curved wall 136 having a first end 133 and a second end 135. The first end 133 of the curved wall 136 may be configured for attachment to a vehicle surface, for example, the top surface of a trailer. The first end 133 of the curved wall 136 may optionally function as the mounting flange 142 or the mounting flange 142 may extend from the first end 133, as seen in FIG. 5B. In some embodiments, the mounting flange 142 has little or no radius of curvature, and provides a substantially flat face to mount on the top surface 28 of the trailer 24 or other vehicle.

The curved wall 136 may extend away from the mounting flange 142, at a radius of curvature of between about 11 inches and about 31 inches when the curved wall 136 (or the mounting flange 142) is mounted to the vehicle surface. A first end 137 of a rounded edge 138 is connected to the second end 135 of the curved wall 136, wherein the rounded edge 138 may have a radius of curvature ranging from between about 0.1 inches and about 2 inches. In some embodiments, the radius of curvature of the rounded edges 138 is different than the radius of curvature of the curved wall 136. A substantially flat wall 140 extends from a second end 139 of the rounded edge 138. In some embodiments, the substantially flat wall 140 extends toward a vehicle mounting surface (when attached to a vehicle), which could be a variety of different surfaces. For example, an end 143 of the substantially flat wall 140 may be connected to the mounting flange 126 or to one or more mounting tabs, as discussed previously. The substantially flat wall 140 may be disposed at an angle A1, as seen in FIG. 5B, of between about 60 degrees and about 90 degrees, or between about 70 and about 80 degrees, or between about 80 and about 90 degrees, with respect to the mounting surface.

The top fairing structure 102 may be designed to be entirely enclosed throughout the entire structure, or with one or more open surfaces. The top fairing structure 102 may be solid throughout, hollow throughout, or a combination of filled and unfilled. In some embodiments, a cavity 170 is defined by the shape of the fairing structure 102. In such embodiments, the curved wall 136 may have a curved wall inner surface and a curved wall outer surface, the rounded edge 138 may have inner and outer rounded edge surfaces, and the substantially flat wall may include inner and outer surfaces as well. In such embodiments, the curved wall outer surface, rounded edge outer surface, and substantially flat wall outer surface form an aerodynamic surface, while the curved wall inner surface, rounded edge inner surface, and substantially flat wall inner surface form a cavity 170. The thickness of the curved wall 136, rounded edge 138, and substantially flat wall 140 may be held constant throughout these surfaces or may vary, depending on the desired structure and manufacturing method used. In some embodiments, the thickness of each of the curved wall 136, the rounded edge 138, and the flat wall 140 may be between about 0.002 inch and about 0.25 inch or thicker.

Referring again to FIG. 5A, the top fairing structure 102 may comprise a plurality of linear fairing segments. In some embodiments, top fairing structure 102 may be configured to include a first linear fairing segment 107, a second linear fairing segment 108, and a third linear fairing segment 109. Second linear fairing segment 108 may be substantially perpendicular to the first linear fairing segment 107. Optionally, third linear fairing segment 109 may be aligned substantially parallel with the second linear fairing segment 108, and may be perpendicular to the first linear fairing segment 107 as well.

The second and third linear fairing segments 108 and 109 may also comprise curved walls, rounded edges, and substantially flat walls, similar to the first linear fairing segment 107. In some embodiments, a portion of the second (and optionally the third) linear fairing segment 108 and a portion of the first linear fairing segment 107 have substantially similar geometry, and may have similar cross-sectional shapes. In some embodiments, portions of the second linear fairing segment 108 and the third linear fairing segment 109 may have substantially similar geometry to portions of the second or third fairing structures 104 and 106, as discussed in more detail below. In some embodiments, the cross-sectional shape of second and third linear fairing segments 108 and 109 is substantially similar to the cross-sectional shape of a portion of second fairing structure 104 or third fairing structure 106. Optionally, the second linear fairing segment 108 and the third linear fairing segment 109 may include depressions as well. In some embodiments, the second linear fairing segment 108 and third linear fairing segment 109 may comprise a coupling cavity, which is described in greater detail below.

Turning now to FIGS. 6A and 6B, coupling arms 144 formed by the second and third fairing segments 108, 109 extend away from the top fairing structure 102 and form coupling cavities 145 at ends thereof. The coupling cavities 145 may be designed in a number of ways and shapes. In some embodiments, the coupling cavities 145 are designed to accommodate ends of the first and second side fairing structures 104, 106. To accommodate the side fairing structures 104, 106, the coupling cavities 145 may be designed to have a curved wall 160, which may have a radius of curvature similar to that of the curved wall 136. The curved wall 160 may extend towards a rounded edge 162, which may have a similar radius of curvature as rounded edge 138, or may vary. A substantially flat wall 164 may extend from the rounded edge 162 and a mounting pad 166 or surface, or may extend to a slightly rounded edge and terminate. In some embodiments, the coupling cavities 145 may be shaped such that they have an exterior surface substantially similar to the first and/or second side fairing structures 104, 106.

With reference to FIG. 6A, the bottom side of mounting flange 142 can be seen. In some embodiments, mounting flange 142 has a plurality of apertures 146 to allow the mounting pad to be coupled to a top surface of a trailer. The number of apertures 146 may vary, and may be spread out evenly about the top mounting pad, or arranged differently, such that they are still able to accommodate coupling to a surface. In some embodiments, top mounting flange 142 does not have apertures, and may be designed to be coupled to a surface in a different way, such as adhesively, for example.

Referring to FIG. 6B, a cross-sectional view of one of the coupling cavities 145 is shown. The curved wall 160 forming a portion of the coupling cavity 145 may also be equipped with depressions 120, as described in more detail above. The coupling cavity 145 may have similar geometry to the cross-section of the curved wall 136, the rounded edge 138, and the substantially flat wall 140, shown and described with respect to FIG. 5B. In some embodiments, the radius of curvature of the curved wall 136 and curved wall 160 are similar, such as for instance, both may be 21.0 inches. The radius of curvature may vary however. For example, it is fully within the scope of the present disclosure to use a radius of curvature between about 11 inches and about 31 inches for the curved wall 160. Similarly, it is contemplated that the radius of curvature of curved wall 136 and curved wall 160 may be different, and may vary by several inches. In some embodiments, the rounded edge 162 may have a radius of curvature ranging between about 0.1 inch and about 2 inches. The substantially flat wall 164 may be disposed at an angle of between about 60 degrees and about 90 degrees, or between about 70 and about 90 degrees, or between about 80 and about 90 degrees, with respect to the mounting surface, similar to substantially flat wall 140.

Turning now to FIGS. 7A-7D, the first side fairing structure 104 is depicted, it being understood that the second side fairing structure 106 may be a mirror image of the first side fairing structure 104 (or substantially symmetrical with respect to a central axis. As such, each feature described with respect to first side fairing structure 104 should be understood as similarly being applicable to second side fairing structure 106. Similarly, it should be understood that some embodiments may contain first and second side fairing structures that are not substantially symmetrical (i.e., not mirror image).

The first side fairing structure 104 may be configured to be coupled with the top fairing structure 102, or may be functional without being coupled to another fairing structure. Similar to top fairing structure 102, the first side fairing structure 104 comprises a curved wall 154. The curved wall 154 may have a first end 151 and a second end 153, and the first end may extend towards a mounting feature, such as outer mounting flange 132. The second end 153 of the curved wall 154 may extend towards a first end 155 of rounded edge 156. A second end 157 of the rounded edge 156 may extend towards a first end 159 of substantially flat wall 158. The substantially flat wall 158 may then extend away from the rounded edge towards a second end 161, which may be connected to a mounting surface, such as inner mounting flange 134.

The radius of curvature of the curved wall 154 may be between about 11 inches and 31 inches. In some embodiments, the radius of curvature of the curved wall 154 and the radius of curvature of the curved wall 136 are substantially similar. For example, the radius of curvature of the curved wall 154 and radius of curvature of the curved wall 136 may vary from each other by less than six inches. In some embodiments, they may vary from each other by less than one inch, or by less than a quarter inch. The radius of curvature of the rounded edge 156 may be between about 0.1 inches and about 2 inches, or may vary. In some embodiments, the radius of curvature of the rounded edge 156 is about one inch. The substantially flat wall 158 may be disposed at an angle of between about 60 degrees and about 90 degrees, or between about 70 and about 90 degrees, or between about 80 and about 90 degrees, with respect to the mounting surface.

The first side fairing structure 104 may have an angled coupling section 150, which can be configured to nest within the coupling cavity 145 of the top fairing structure 102. To fit within the coupling cavity 145, the radius of curvature of a curved surface 149 or other dimensions of the angled coupling section 150 may be reduced slightly. This allows the angled coupling section 150 to pass through a portion of the coupling cavity 145, as will be discussed in more detail below.

In some embodiments, the first and/or second side fairing structures 104, 106 may be designed to be entirely enclosed throughout the entire assembly 20, or with one or more open surfaces. The first side fairing structure 104 may be solid throughout, hollow throughout, or a combination of filled and unfilled. In some embodiments, a cavity 180 is defined by the shape of the fairing structure 104. In such embodiments, the curved wall 154 may have a curved wall inner surface and a curved wall outer surface, the rounded edge 156 may have inner and outer rounded edge surfaces, and the substantially flat wall 158 may include inner and outer surfaces as well. In such embodiments, the curved wall outer surface, rounded edge outer surface, and substantially flat wall outer surface form an aerodynamic surface, while the curved wall inner surface, rounded edge inner surface, and substantially flat wall inner surface form a cavity 180. The thickness of the curved wall 154, rounded edge 156, and substantially flat wall 158 may be held constant throughout these surfaces or may vary, depending on the desired structure and manufacturing method used. In some embodiments, the thickness of the walls in the fairing structure 104 may be 0.002″ or thicker and about 0.25 inch or thicker.

Referring to FIG. 7D, a cross section of the fairing structure 104 is taken at a location in the curved wall 154 that includes depressions 120. In such areas, the depression 120 may cause the radius of curvature to increase, as material is removed therefrom. For example, a depression 120 may have a radius of curvature of about 30 inches, while the radius of curvature of the curved wall 154 may be about 21 inches. Depressions 120 may occur gradually or may have a constant thickness. Similarly, depressions 120 may vary in shape and location throughout the fairing structures 102, 104, 106.

Referring now to FIGS. 8A and 8B, assembly of the aerodynamic nose device 100 is depicted. More particularly, one matter of attachment of the first and second side fairing structures 104, 106 to the fairing structure 102 is depicted. As can be seen, the angled coupling section 150 of the first side fairing structure 104 may present an area of decreased size to be received within coupling cavity 145. The angled coupling section 150 may be sized such that an interference fit is made with the walls forming the coupling cavity 145, a transition fit is formed with walls forming the coupling cavity 145, or a clearance fit is formed with walls forming the coupling cavity 145. In some embodiments, the outer surfaces of the top fairing structure 102 and the first and second side fairing structures 104, 106 are designed such that once the fairing structures 104, 106 have been coupled to the top fairing structure 102, the components form one or more substantially flush joint surfaces, as seen in FIG. 8B. Additionally, it should be appreciated that the coupling cavities 145 could be placed on the fairing structures 104, 106 and the angled coupling section 150 could be positioned on the top fairing structure 102, such that portions of the top fairing structure 102 are received within or joined with portions of the fairing structures 104, 106. Additionally, it should be understood that some embodiments may not include a nesting-style coupling, and may instead provide any other suitable methods of coupling.

Now turning to FIG. 8B, the angled mounting surface 150 has been received within the mounting cavity 145, such that the coupling arm 144 overlaps a portion of the angled mounting surface 150. The coupling of the components may then occur in a variety of ways. In some embodiments, fasteners are used to strengthen the coupling between the top fairing structure 102 and the first side fairing structure 104. Optionally, various adhesives may be used to mount the structures together. Additionally, in some embodiments, a welded, brazed, or soldered joint may be created. Those skilled in the art will appreciate that other fastening and connecting means can be used to couple the top fairing structure 102 and the first side fairing structure 104, and are fully within the confines of the present disclosure.

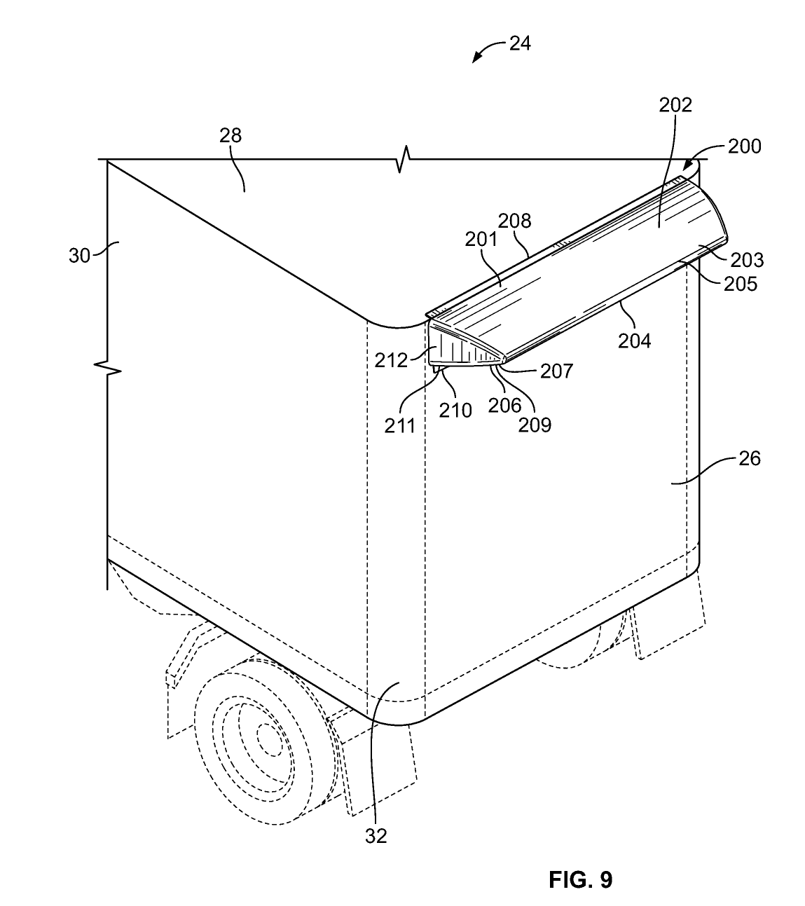

Turning now to FIG. 9, an alternative embodiment of an aerodynamic nose device 200 is provided. The aerodynamic nose device 200 comprises a single fairing structure. The fairing structure may have a curved wall 202 having a first end 201 and a second end 203. The first end 201 of the curved wall may be coupled to a mounting surface 208, which may be the top surface 28 of a trailer 24, side surface 30, front surface 26, or a combination of surfaces. A rounded edge 204 extends from the second end 203 of the curved wall 202 and extends toward a first end 209 of a substantially flat wall 206. The substantially flat wall 206 extends between the rounded edge 204 and a mounting surface 210. The mounting surface 210 may be coupled to a front surface 26 of a trailer 24, side surface 30, or any other suitable surface or combination of surfaces. The aerodynamic nose device 200 may further comprise side walls 212, which may enclose the exterior shape defined by one or more of the mounting surface 208, the curved wall 202, the rounded edge 204, the substantially flat wall 206, and the mounting surface 210. In some embodiments, the side walls 212 may be omitted.

The curved wall 202 may extend away from the mounting flange 208, at a radius of curvature between about 11 inches and about 31 inches. In some embodiments, the radius of curvature may vary throughout. The radius of curvature of the rounded edge 204 may vary as well, or can be between about 0.1 inches and about 2 inches. In some embodiments, the radius of curvature of the rounded edge 204 is about one inch. The substantially flat wall 206 may be disposed at an angle of between about 60 degrees and about 90 degrees, or between about 70 and about 90 degrees, or between about 80 and about 90 degrees, with respect to the mounting surface.

Similar to the mounting surfaces discussed earlier, the mounting surfaces 208 and 210 may take on a variety of different forms. The mounting surfaces may comprise several apertures for attaching fasteners, may provide a smooth surface for applying adhesive, or may provide any mounting surface deemed suitable for use by those skilled in the art. The mounting surfaces 208 and 210 may provide a single mounting surface, a plurality of mounting tabs, or other possible configurations. The mounting surfaces may be configured to mount parallel or substantially parallel to a surface of a trailer, or could be arranged differently, if desired.

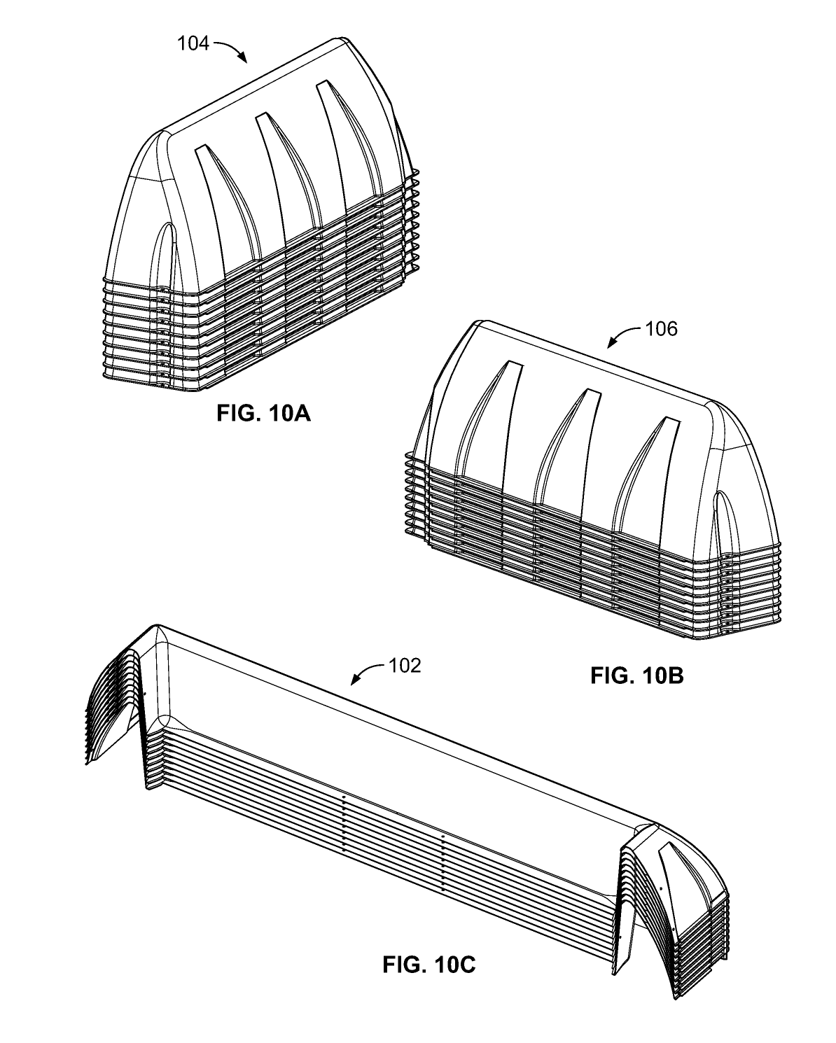

Turning now to FIGS. 10A-10C, several fairing structures 102, 104, and 106 are shown stacked within one another. As discussed earlier with reference to some embodiments of the present disclosure, the fairing structures may be designed to have a cavity defined by an inner surface of a curved wall, inner surface of a rounded edge, and inner surface of a substantially flat wall. In some embodiments having a cavity, the cavity may be designed so as to accommodate another identical or nearly identical fairing structure within the cavity. Such a design may allow for the stacking of several like components, which may reduce the necessary storage space to store several components. Reducing the space requirements for several components may allow for the shipping of larger quantities of each fairing structure. Embodiments incorporating these features may also be readily manufactured via molding processes, given the geometry of the components.

It should be appreciated that a number of different materials and construction methods are contemplated by the present disclosure. In some embodiments, a resilient material may be desirable. In some embodiments, a thermoplastic olefin, (TPO), may be used to produce aerodynamic nose devices contemplated within the present disclosure. Such a material selection may provide resistance to possible axial loading, while providing resilience, should some deflection in a fairing structure occur. These deformable materials may allow the device to withstand impacts and return to its original shape. In some instances, thin sheet metal, polymers, composites, and other materials may also provide desirable qualities for aerodynamic nose devices, and can be used to form such devices. In some embodiments, an aerodynamic nose device may comprise several materials.

Additionally, a number of different manufacturing processes are capable of producing the structures described herein and other structures that fall within the confines of the present disclosure. Thermoforming, injection molding, blow molding, compression molding, and other polymer processes may be capable of producing such fairing structures. Similarly, metalworking processes like casting, forging, and machining are just some examples of processes that may be used to produce metal parts within the present disclosure.

While the aerodynamic nose devices of the present disclosure are shown as being attached to a trailer of, for example, a semi tractor-trailer, any of the aerodynamic nose devices disclosed herein may be attached to truck bodies, dry van or refrigerated trailers, refrigerated dry vans, flat beds, tanks, or any other vehicles.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An aerodynamic nose device configured to be coupled to a front surface of a vehicle, the nose device comprising:
a continuous c-shaped fairing structure configured to be attached to a vehicle surface, the fairing c-shaped fairing structure including a first segment, a second segment extending from a first end of the first segment, and a third segment extending from a second end of the first segment, the first segment comprising:
a curved wall having a first end and a second end, the first end configured for attachment to the vehicle surface, the curved wall having a radius of curvature of between about 11 inches and about 31 inches;
a rounded edge having a first end and a second end, the first end of the rounded edge being connected to the second end of the curved wall; and
a substantially flat wall having a first end and a second end, the first end being connected to the second end of the rounded edge and the second end configured to be positioned adjacent the vehicle surface, wherein the flat wall is disposed at an angle of between about 60 degrees and about 90 degrees with respect to the vehicle surface.

2. The aerodynamic nose device of claim 1, further including a mounting flange extending from the first end of the curved wall, the mounting flange configured to be attached to a second vehicle surface extending generally transverse to the first-named vehicle surface.

3. The aerodynamic nose device of claim 1, wherein the curved wall includes inner and outer curved wall surfaces, the rounded edge includes inner and outer rounded edge surfaces, and the substantially flat wall includes inner and outer flat wall surfaces wherein the curved wall outer surface, the rounded edge outer surface, and the flat wall outer surface form an aerodynamic surface and the curved wall inner surface, the rounded edge inner surface, and the flat wall inner surface form a cavity.

4. The aerodynamic nose device of claim 3, further including a second fairing structure comprising a second curved wall, a second rounded edge, and a second substantially flat wall, wherein the second fairing structure is nested within the cavity of the fairing structure with an outer surface of the second curved wall adjacent the curved wall inner surface, an outer surface of the second rounded edge adjacent the rounded edge inner surface, and an outer surface of the second substantially flat wall adjacent the flat wall inner surface.

5. The aerodynamic nose device of claim 1, further comprising:
a second fairing structure coupled to the first-named fairing structure, the second fairing structure comprising a second curved wall, a second rounded edge, and a second substantially flat wall, the second fairing structure being coupled to a first end of the first-named fairing structure and positioned at an angle of about 90 degrees with respect to the first-named fairing structure; and
a third fairing structure coupled to the first-named fairing structure, the third fairing structure comprising a third curved wall, a third rounded edge, and a third substantially flat wall, the third fairing structure being coupled to a second end of the first-named fairing structure and positioned at an angle of about 90 degrees with respect to the first-named fairing structure, wherein the third fairing structure is parallel to the second fairing structure.

6. The aerodynamic nose device of claim 5, wherein each of the second and third curved walls comprises a plurality of depressions formed therein.

7. The aerodynamic nose device of claim 1, wherein the fairing structure comprises a plurality of depressions formed therein.

8. The aerodynamic nose device of claim 1, wherein the device comprises a thermoplastic olefin (TPO).

9. An aerodynamic nose device configured to be coupled to a front surface of a vehicle, the nose device comprising:
a continuous c-shaped fairing structure configured to be attached to a front surface of a vehicle, the fairing structure comprising:
a first linear fairing segment comprising a curved wall having a first end and a second end, the first end configured for attachment to the front surface of the vehicle and a substantially flat wall having a first end and a second end, the first end being coupled to the second end of the curved wall;
a second linear fairing segment extending substantially perpendicular to a first end of the first linear fairing segment, the second linear fairing segment including an end having a coupling feature adapted to couple with a second fairing structure;
a third linear fairing segment extending substantially perpendicular to a second end of the first linear fairing segment, the third linear fairing segment including an end having a coupling feature adapted to couple with a third fairing structure.

10. The aerodynamic nose device of claim 9, further including a second fairing structure, wherein the coupling feature is a coupling cavity and an end of the second fairing structure extends at least partially into the coupling cavity and is coupled to the second linear fairing segment by an interference fit or by one or more fasteners.

11. The aerodynamic nose device of claim 10, wherein the end of the second linear fairing segment includes a depression and the end of the second fairing structure includes a reduced dimension that conforms to the depression in the end of the second linear fairing segment.

12. The aerodynamic nose device of claim 10, wherein a portion of the second linear fairing segment and a portion of the second fairing structure have similar cross-sectional shapes.

13. (canceled)

14. The aerodynamic nose device of claim 9, further including a third fairing structure, wherein an end of the third fairing structure extends at least partially into the coupling cavity of the third linear fairing segment and is coupled to the third linear fairing segment by an interference fit or by one or more fasteners.

15. The aerodynamic nose device of claim 14, wherein the end of the third linear fairing segment includes a depression and the end of the third fairing structure includes a reduced dimension that conforms to the depression in the end of the third linear fairing segment.

16. An aerodynamic nose device configured to be coupled to a front surface of a vehicle, the aerodynamic nose device comprising:
a first fairing structure configured to be coupled to a front surface of a vehicle, the first fairing structure comprising:
a first wall having a first end and a second end with at least one of the first and second ends configured for attachment to the front surface, the first wall further including an inner surface and an outer surface;
a first aerodynamic surface at least partially defined by the outer surface; and
a first enclosed cavity at least partially defined by the inner surface; and
a second fairing structure configured to be coupled to a front surface of a vehicle, the second fairing structure comprising:
a second wall having a first end and a second end with at least one of the first and second ends configured for attachment to the front surface, the second wall further including an inner surface and an outer surface;
a second aerodynamic surface at least partially defined by the outer surface of the second wall; and
a second enclosed cavity at least partially defined by the inner surface of the second wall;
wherein substantially the entire second fairing structure is nested within the first enclosed cavity of the first fairing structure with substantially the entire outer surface of the second wall of the second fairing structure positioned adjacent the inner surface of the first wall of the first fairing structure to allow the first and second fairing structures to be stacked for storage or transport of multiple fairing structures.

17. The aerodynamic nose device of claim 16, wherein the first wall comprises:
a first curved wall section having a first end and a second end;
a first rounded edge having a first end and a second end, the first end of the first rounded edge being coupled to the second end of the first curved wall section; and
a first substantially flat wall section having a first end and a second end, the first end being coupled to the second end of the first rounded edge and the second end being coupled to a mounting surface that is configured to be coupled to the front surface of the vehicle.

18. The aerodynamic nose device of claim 17, wherein the second wall comprises:
a second curved wall section having a first end and a second end;
a second rounded edge having a first end and a second end, the first end of the second rounded edge being coupled to the second end of the second curved wall section; and
a second substantially flat wall section having a first end and a second end, the first end being coupled to the second end of the second rounded edge and the second end being coupled to a mounting surface that is configured to be coupled to the front surface of the vehicle.

19. The aerodynamic nose device of claim 16, further comprising:
a right vertical fairing structure configured to be coupled to the first fairing structure and positioned at an angle of about 90 degrees with respect to the first fairing structure; and
a left vertical fairing structure configured to be coupled to the first fairing structure and positioned at an angle of about 90 degrees with respect to the first fairing structure, wherein the left vertical fairing structure is configured to be parallel to the right vertical fairing structure.

20. The aerodynamic nose device of claim 19, further including a second right vertical fairing structure nested within the right vertical fairing structure and a second left vertical fairing structure nested within the left vertical fairing structure.
